(19) United States
(12) Patent Application Publication
(10) Pub. No.: US 2026/0324596 A1
(43) Pub. Date: Oct. 22, 2026

(54) INTELLIGENT COLLAR DEVICE FOR ANIMAL

(71) Applicant: Hable Hound Inc, Dover, DE (US)

(72) Inventors: Xiaoxuan Chen, Shenzhen (CN); Jian Huang, Shenzhen (CN); Yanbo Zheng, Shenzhen (CN)

(21) Appl. No.: 19/688,584

(22) Filed: May 27, 2026

(30) Foreign Application Priority Data
Mar. 19, 2026 (CN) 202620348003.2

(51) Int. Cl. A01K 27/00; H02S 20/30

(52) U.S. Cl. CPC A01K 27/001; A01K 27/009; H02S 20/30

(57) ABSTRACT

An intelligent collar device for an animal includes a wearing band, a first functional assembly, a photovoltaic panel, a GNSS antenna and a gravity self-resetting mechanism. The first functional assembly includes a housing having a predetermined surface area that faces away from a centerline encircled by the wearing band. The photovoltaic panel is disposed on the predetermined surface area. The GNSS antenna is adjacent to the photovoltaic panel. In the worn state of the wearing band, the gravity self-resetting mechanism is configured to generate, upon deviation of the first functional assembly from a predetermined orientation, a gravitational resetting torque that self-resets about the centerline, thereby causing the predetermined surface area, the GNSS antenna, and the photovoltaic panel to collectively face skyward.

### CROSS REFERENCE TO RELATED APPLICATIONS

The present application claims the benefit of Chinese Patent Application No. 202620348003.2 filed on Mar. 19, 2026, the contents of which are incorporated herein by reference in their entirety.

### FIELD OF THE INVENTION

The present disclosure relates to the field of animal related products, and particularly to an intelligent collar device for an animal.

### BACKGROUND OF THE INVENTION

It is well known that wearable electronic devices of the collar type for animals often integrate functions such as positioning, communication, illumination, or training. Under operating conditions involving animal movement, running, rolling, or similar activities, such devices are susceptible to orientation flipping or rotation, leading to instability in the orientation of the upper surface of the wearable electronic collar device.

When such a wearable electronic collar device integrates photovoltaic power supply and satellite positioning reception, unstable orientation of the device may cause fluctuations in light reception conditions for the photovoltaic panel and a reduction in average light-receiving area. It may also compromise the skyward-facing orientation of a GNSS antenna, thereby reducing the stability of energy harvesting and positioning reception. Furthermore, due to stringent space, weight, and reliability constraints for wearable electronic collar devices, introducing separate components for orientation stabilization, light-receiving surface orientation, and electrode assembly tends to result in increased structural complexity, higher assembly costs, and reduced reliability.

Accordingly, there is a need for an intelligent collar device for an animal that can provide more stable photovoltaic light reception and GNSS reception orientation under animal movement conditions.

### SUMMARY OF THE INVENTION

An object of the present disclosure is to provide an intelligent collar device for an animal that achieves more stable photovoltaic light reception and GNSS reception orientation under animal movement conditions.

To achieve the above object, the present disclosure provides an intelligent collar device for an animal, including:
a wearing band configured to be worn around a neck of the animal;
a first functional assembly mounted on the wearing band, the first functional assembly including a housing having a predetermined surface area that, in a worn state of the wearing band, faces away from a centerline encircled by the wearing band;
a photovoltaic panel disposed on the predetermined surface area, the photovoltaic panel being configured to power the first functional assembly in the worn state;
a GNSS antenna disposed within or operatively associated with the first functional assembly, the GNSS antenna being adjacent to the photovoltaic panel; and
a gravity self-resetting mechanism disposed on a side opposite to the predetermined surface area with respect to the centerline, wherein in the worn state, the gravity self-resetting mechanism is configured to generate, upon deviation of the first functional assembly from a predetermined orientation, a gravitational resetting torque that self-resets about the centerline, thereby causing the predetermined surface area, the GNSS antenna, and the photovoltaic panel to collectively face skyward.

Compared with the prior art, the intelligent collar device for an animal according to the present disclosure utilizes the gravity self-resetting mechanism to bias the center of gravity of the device downward relative to the centerline encircled by the wearing band. Once the first functional assembly deviates from a predetermined orientation, the gravity self-resetting mechanism generates a gravitational resetting torque that self-resets about the centerline encircled by the wearing band, thereby causing the predetermined surface area, the GNSS antenna, and the photovoltaic panel to collectively face skyward. In such an arrangement, the light reception of the photovoltaic panel and the reception orientation of the GNSS antenna are more stable.

In a preferred embodiment, in the worn state, the gravity self-resetting mechanism is configured to bias a center of gravity of the intelligent collar device downward relative to the centerline encircled by the wearing band.

In a preferred embodiment, the gravity self-resetting mechanism includes a stimulation electrode assembly and a mechanism body connected to the housing of the first functional assembly; and wherein in the worn state, the stimulation electrode assembly contacts the neck of the animal and restricts rotational movement of the first functional assembly about the centerline encircled by the wearing band.

In a preferred embodiment, the mechanism body includes a plurality of second functional assemblies spaced apart from each other along the wearing band, and the stimulation electrode assembly is electrically connected to one of the second functional assemblies; and wherein the photovoltaic panel is further configured to power the second functional assemblies in the worn state.

In a preferred embodiment, the stimulation electrode assembly includes at least one conductive electrode, the conductive electrode being a columnar electrode, a plate-shaped electrode, or a toothed electrode; and wherein the conductive electrode includes an elastic cushioning contact member configured therein and/or a rounded end.

In a preferred embodiment, the gravity self-resetting mechanism includes a weight or a thickened portion provided on the wearing band.

In a preferred embodiment, the first functional assembly includes a plurality of first assemblies spaced apart from each other along the wearing band, and wherein in the worn state, an angle between the photovoltaic panels on two outermost ones of the first assemblies is equal to or less than 120 degrees.

In a preferred embodiment, wherein the GNSS antenna is disposed between two adjacent first assemblies.

In a preferred embodiment, the photovoltaic panel includes a gallium arsenide solar cell; and the GNSS antenna includes a patch antenna or a ceramic antenna.

In a preferred embodiment, the gallium arsenide solar cell includes a multi-junction gallium arsenide solar cell.

### BRIEF DESCRIPTION OF THE DRAWINGS

The accompanying drawings facilitate an understanding of the various embodiments of this invention. In such drawings:

FIG. 1 is a perspective view of the intelligent collar device for an animal according to the present disclosure in a worn state;

FIG. 2 is an exploded perspective view of the intelligent collar device for an animal in the state shown in FIG. 1;

FIG. 3 is a plan view of the intelligent collar device for an animal in the state shown in FIG. 1, viewed in the direction indicated by arrow A;

FIG. 4 is a state view of the intelligent collar device of FIG. 3 wearing on the animal's neck; and

FIG. 5 is an internal view of the intelligent collar device for an animal in the state shown in FIG. 1, with the wearing band hidden and taken along a plane cut through the centerlines of two conductive electrodes.

### DETAILED DESCRIPTION OF ILLUSTRATED EMBODIMENTS

The technical content and structural features of the present disclosure will be described in detail below with reference to the accompanying drawings and exemplary embodiments.

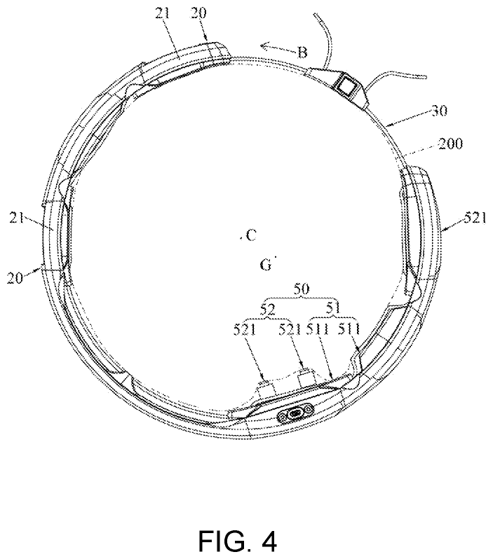

Referring to FIG. 4, an intelligent collar device 100 for an animal according to the present disclosure is adapted to be circumferentially worn around an animal's neck 200, as needed.

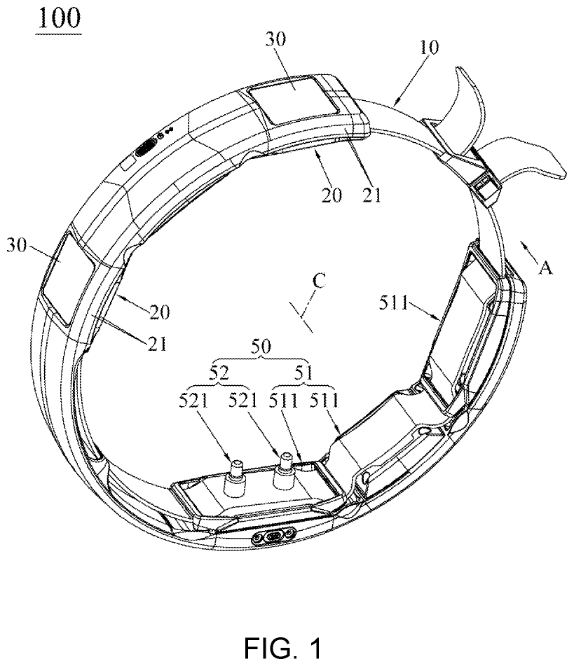

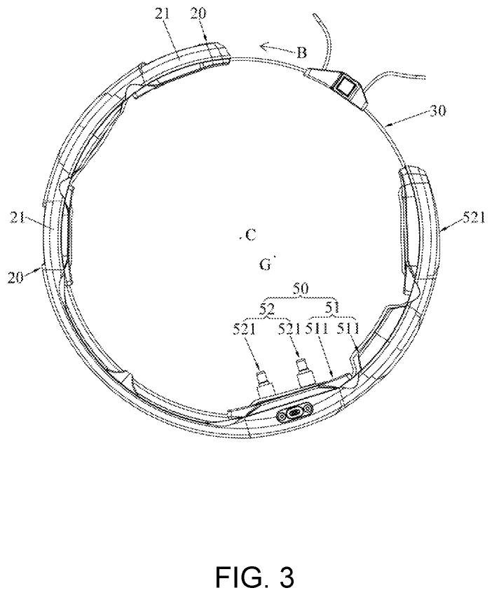

Referring further to FIGS. 1 to 4, the intelligent collar device 100 for the animal of the present disclosure includes a wearing band 10, a first functional assembly 20, a photovoltaic panel 30, a GNSS antenna 40, and a gravity self-resetting mechanism 50. The wearing band 10 is configured to be circumferentially worn around the animal's neck 200, such that when worn, the wearing band 10 defines a centerline C encircled by the wearing band 10. In the drawings, arrow A indicates a viewing direction for FIG. 3, and arrow B (or the opposite direction thereof) indicates the encircling direction of the wearing band 10.

The first functional assembly 20 is mounted on the wearing band 10, so that the first functional assembly 20 can be worn on the animal's neck 200 via the wearing band 10. The first functional assembly 20 includes a housing 21 for accommodating circuit components within the first functional assembly 20 and providing waterproof, dustproof, and/or impact-resistant protection. The housing 21 of the first functional assembly 20 has a predetermined surface area 211 that, when the wearing band 10 is worn, faces away from the centerline C encircled by the wearing band 10, thereby ensuring that the predetermined surface area 211 and the animal's neck 200 face away from each other.

The photovoltaic panel 30 is disposed on the predetermined surface area 211 of the housing 21 of the first functional assembly 20. In the worn state of the wearing band, the photovoltaic panel 30 powers the first functional assembly 20, so as to satisfy the power consumption or storage requirements of the first functional assembly 20. Optionally, as an embodiment shown in FIGS. 1, 2, and 5, two first assemblies 20 are configured and spaced apart from each other along the wearing band 10. In the worn state of the wearing band, the angle α between the photovoltaic panels 30 on the two first assemblies 20 is equal to or less than 120 degrees. Such a configuration allows the photovoltaic panels 30 to maintain a relatively large effective light-receiving area even under local shading or slight orientation perturbations caused by animal movement, thereby improving the circumferential light-receiving coverage continuity and shading tolerance of the photovoltaic panels 30. Depending on actual needs, the number of first assemblies 20 may alternatively be one, three, four, or more, and thus the present disclosure is not limited to the configuration shown in FIGS. 1, 2, and 5.

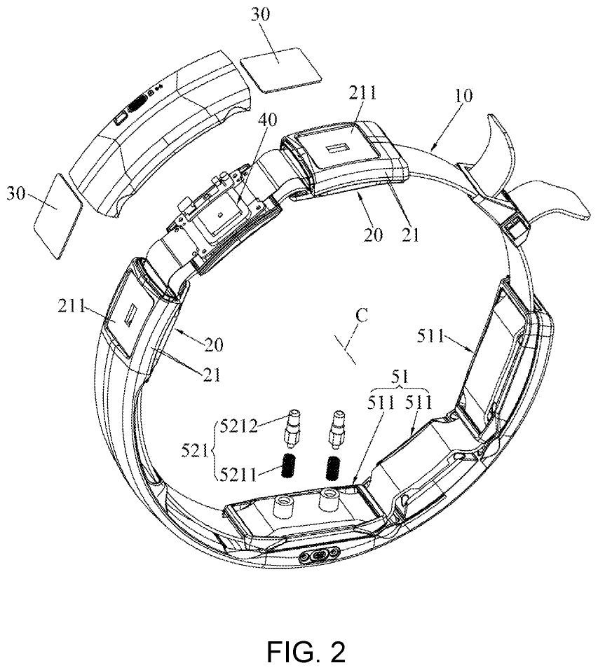

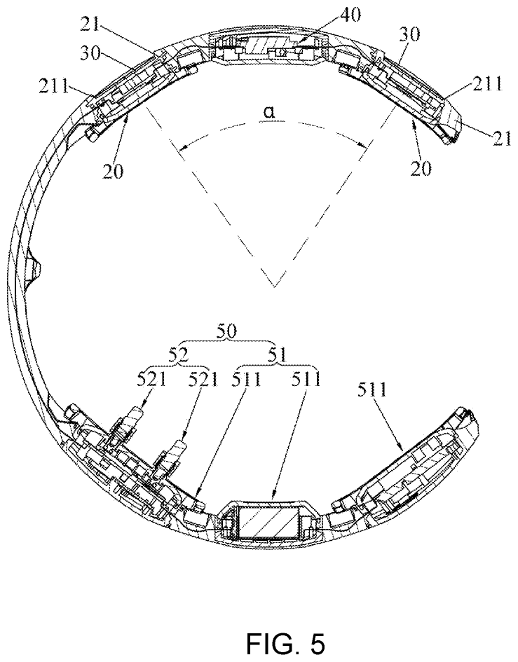

The GNSS antenna 40 is operatively associated with the first functional assembly 20. It will be appreciated that depending on actual needs, the GNSS antenna 40 may alternatively be disposed within the first functional assembly 20 (specifically, within the housing 21 of the first functional assembly 20), and thus the present disclosure is not limited to the configurations shown in FIGS. 1-5. Additionally, the GNSS antenna 40 is adjacent to the photovoltaic panel 30. Optionally, as an embodiment shown in FIG. 5, the GNSS antenna 40 is located beside the photovoltaic panel 30, so as to ensure, in the worn state of the wearing band 10, that the GNSS antenna 40 and the photovoltaic panel 30 have substantially the same light reception orientation, facing to the sky. Optionally, as an embodiment shown in FIGS. 2 and 5, when two first assemblies 20 are configured and spaced apart from each other along the wearing band 10, the GNSS antenna 40 is disposed between the two first assemblies 20. In such a configuration, the photovoltaic panels 30 are disposed on opposite sides of the GNSS antenna 40, thereby placing the GNSS antenna 40 in a more favorable signal reception orientation.

In the worn state of the wearing band 10, the gravity self-resetting mechanism 50 is arranged on a side opposite to the predetermined surface area 211 with respect to the centerline C encircled by the wearing band 10. For example, the gravity self-resetting mechanism 50 is arranged on the lower side of the centerline C, while the predetermined surface area 211 is arranged on the upper side of the centerline C, as shown in FIGS. 1-4. When the first functional assembly 20 deviates from a predetermined orientation, the gravity self-resetting mechanism 50 generates a gravitational resetting torque that self-resets about the centerline C encircled by the wearing band 10, thereby causing the predetermined surface area 211, the GNSS antenna 40, and the photovoltaic panel 30 to together face skyward. Specifically, as an embodiment shown in FIGS. 1-4, when the wearing band 10 is worn, the gravity self-resetting mechanism 50 biases the center of gravity G of the intelligent collar device 100 for an animal downward relative to the centerline C encircled by the wearing band 10. Accordingly, when the animal's movement causes the first functional assembly 20 to deviate from a predetermined orientation (e.g., tilting left, right, or downward), the gravity self-resetting mechanism 50 generates a corresponding gravitational resetting torque that self-resets about the centerline C, and this gravitational resetting torque drives the first functional assembly 20 to automatically reset about the centerline C, thereby maintaining the predetermined surface area 211, the GNSS antenna 40, and the photovoltaic panel 30 in a skyward-facing orientation. Further details are described below.

As shown in FIGS. 1 to 5, as an embodiment, the gravity self-resetting mechanism 50 includes a mechanism body 51 and a stimulation electrode assembly 52. The mechanism body 51 is connected to the housing 21 of the first functional assembly 20, so as to connect the gravity self-resetting mechanism 50 to the first functional assembly 20. When the wearing band 10 is worn, the stimulation electrode assembly 52 contacts the animal's neck 200. The stimulation electrode assembly 52, by contacting the animal's neck 200, also restricts rotational movement (undesired self-rotation) of the first functional assembly 20 about the centerline C encircled by the wearing band 10, thereby reducing orientation drift of the first functional assembly 20 under dynamic conditions and further enhancing the stability of maintaining the predetermined surface area 211, the GNSS antenna 40, and the photovoltaic panel 30 together in a skyward-facing orientation. Thus, the stimulation electrode assembly 52 serves both an electrode function and an anti-rotation function, so that the intelligent collar device 100 according to the present disclosure achieves a reduction in the number of components, lower assembly complexity, and improved structural compactness and reliability. Specifically, as an embodiment shown in FIGS. 1-5, the mechanism body 51 includes three second functional assemblies 511 spaced apart from each other along the wearing band 10. Depending on actual needs, the number of second functional assemblies 511 may alternatively be one, two, four, or more, and thus the present disclosure is not limited to the configuration shown in FIGS. 1-5. In this configuration, the stimulation electrode assembly 52 is electrically connected to one of the second functional assemblies 511, and the photovoltaic panel 30 further powers the second functional assemblies 511 in the worn state of the wearing band 10, so as to satisfy the power consumption or storage requirements of the second functional assemblies 511. Additionally, as an embodiment shown in FIGS. 1-5, the stimulation electrode assembly 52 includes two spaced-apart conductive electrodes 521. Depending on actual needs, the stimulation electrode assembly 52 may alternatively include one, three, or more conductive electrodes 521, and thus the present disclosure is not limited to the configuration shown in FIGS. 1-5. More specifically, as an embodiment shown in FIG. 2, the conductive electrodes 521 include an elastic cushioning contact member 5211 disposed therein, and/or the conductive electrodes 521 are provided with rounded ends 5212, so as to improve wearing comfort of the intelligent collar device 100 for an animal. Further, the conductive electrodes 521 may be columnar electrodes, plate-shaped electrodes, or toothed electrodes. It should be noted that depending on actual needs, the conductive electrodes 521 may alternatively include only the elastic cushioning contact member 5211 or only have rounded ends 5212, and thus the present disclosure is not limited to the configuration shown in FIG. 2.

As shown in FIGS. 1, 2, and 5, as an embodiment, the photovoltaic panel 30 is a gallium arsenide solar cell which has a high output capacity per unit area and is particularly suitable for providing sustained power to the first functional assembly 20 and the second functional assemblies 511 under the area-limited conditions of the upper surface of the intelligent collar device 100 for an animal. Specifically, the gallium arsenide solar cell is a multi-junction gallium arsenide solar cell, to further enhance the output capacity per unit area.

As shown in FIG. 2, as an embodiment, the GNSS antenna 40 is a patch antenna or a ceramic antenna, so as to further improve the reliability of satellite signal reception.

Compared with the prior art, the intelligent collar device 100 for an animal according to the present disclosure utilizes the gravity self-resetting mechanism 50 to bias the center of gravity G of the device 100 downward relative to the centerline C encircled by the wearing band 10. Once the first functional assembly 20 deviates from a predetermined orientation, the gravity self-resetting mechanism 50 generates a gravitational resetting torque that self-resets about the centerline C encircled by the wearing band 10, thereby causing the predetermined surface area 211, the GNSS antenna 40, and the photovoltaic panel 30 to collectively face skyward. In such an arrangement, the consistency of light reception of the photovoltaic panel 30 and the stability of satellite signal reception conditions are improved, thereby rendering light reception by the photovoltaic panel 30 and the reception orientation of the GNSS antenna 40 more stable.

It is further noted that the gravity self-resetting mechanism 50 configured to bias the center of gravity G of the intelligent collar device 100 for an animal downward relative to the centerline C encircled by the wearing band 10 can be implemented by any one or more of: differences in material density across regions of the housing; increased wall thickness in regions of the housing located below the centerline C encircled by the wearing band 10; relatively concentrated arrangement of metal components, batteries, and/or structural reinforcement members in regions below the centerline C encircled by the wearing band 10; thickening of the wearing band 10 at locations below the centerline C; and weighting of the wearing band 10 at locations below the centerline C. Furthermore, although the drawings show the gravity self-resetting mechanism 50 connected to the first functional assembly 20, depending on actual needs, the gravity self-resetting mechanism 50 may alternatively be implemented as a weight or a thickened portion provided on the wearing band 10. Additionally, each of the first functional assembly 20 and the second functional assemblies 511 may include circuit components related to positioning, communication, sensing, control, or the like. Finally, the direction indicated by arrow B in the drawings or the opposite direction thereof corresponds to the encircling direction of the wearing band 10.

The above disclosure is only preferred embodiments of the present disclosure and shall not be used to limit the scope of rights of the present disclosure. Accordingly, equivalent variations made in accordance with the claims of the present disclosure shall fall within the scope of the present disclosure.

What is claimed is:

1. An intelligent collar device for an animal, comprising:
a wearing band configured to be worn around a neck of the animal;
a first functional assembly mounted on the wearing band, the first functional assembly comprising a housing having a predetermined surface area that, in a worn state of the wearing band, faces away from a centerline encircled by the wearing band;
a photovoltaic panel disposed on the predetermined surface area, the photovoltaic panel being configured to power the first functional assembly in the worn state;
a GNSS antenna disposed within or operatively associated with the first functional assembly, the GNSS antenna being adjacent to the photovoltaic panel; and
a gravity self-resetting mechanism disposed on a side opposite to the predetermined surface area with respect to the centerline, wherein in the worn state, the gravity self-resetting mechanism is configured to generate, upon deviation of the first functional assembly from a predetermined orientation, a gravitational resetting torque that self-resets about the centerline, thereby causing the predetermined surface area, the GNSS antenna, and the photovoltaic panel to collectively face skyward.

2. The intelligent collar device of claim 1, wherein in the worn state, the gravity self-resetting mechanism is configured to bias a center of gravity of the intelligent collar device downward relative to the centerline encircled by the wearing band.

3. The intelligent collar device of claim 1, wherein the gravity self-resetting mechanism comprises a stimulation electrode assembly and a mechanism body connected to the housing of the first functional assembly; and wherein in the worn state, the stimulation electrode assembly contacts the neck of the animal and restricts rotational movement of the first functional assembly about the centerline encircled by the wearing band.

4. The intelligent collar device of claim 3, wherein the mechanism body comprises a plurality of second functional assemblies spaced apart from each other along the wearing band, and the stimulation electrode assembly is electrically connected to one of the second functional assemblies; and wherein the photovoltaic panel is further configured to power the second functional assemblies in the worn state.

5. The intelligent collar device of claim 3, wherein the stimulation electrode assembly comprises at least one conductive electrode, the conductive electrode being a columnar electrode, a plate-shaped electrode, or a toothed electrode; and wherein the conductive electrode comprises an elastic cushioning contact member configured therein and/or a rounded end.

6. The intelligent collar device of claim 1, wherein the gravity self-resetting mechanism comprises a weight or a thickened portion provided on the wearing band.

7. The intelligent collar device of claim 1, wherein the first functional assembly comprises a plurality of first assemblies spaced apart from each other along the wearing band, and wherein in the worn state, an angle between the photovoltaic panels on two outermost ones of the first assemblies is equal to or less than 120 degrees.

8. The intelligent collar device of claim 7, wherein the GNSS antenna is disposed between two adjacent first assemblies.

9. The intelligent collar device of claim 1, wherein the photovoltaic panel comprises a gallium arsenide solar cell; and the GNSS antenna comprises a patch antenna or a ceramic antenna.

10. The intelligent collar device of claim 9, wherein the gallium arsenide solar cell comprises a multi-junction gallium arsenide solar cell.
